(19) United States
(12) Patent Application Publication
(10) Pub. No.: US 2006/0268936 A1
(43) Pub. Date: Nov. 30, 2006

(54) Communication apparatus and method thereof

(75) Inventors: Sung-Uk Hong, Seongnam (KR); Hee-Kon Kim, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/403,018

(22) Filed: Apr. 11, 2006

(30) Foreign Application Priority Data
May 16, 2005 (KR) 40896/2005

(51) Int. Cl. H04J 3/24

(52) U.S. Cl. 370/474

(57) ABSTRACT

A communication apparatus and method are disclosed to transmit at a high speed, reduce power consumption by performing communication between dual processors and improve quality of service by effectively processing the data. The communication apparatus includes a driving unit for fragmenting data packets inputted from a first processor, storing the fragmented data packets in a storage unit, reassembling the fragmented data packets, and transmitting the reassembled data packets to a second processor.

Pursuant to 35 U.S.C. § 119(a), this application claims the benefit of earlier filing date and right of priority to Korean Application No. 10-2005-0040896, filed on May 16, 2005, the contents of which is hereby incorporated by reference herein in its entirety.

### BACKGROUND OF THE INVENTION

1. Field of the Invention

The present invention relates to a mobile terminal and, more particularly, to a communication apparatus of a mobile terminal and its method.

2. Description of the Related Art

Recently, mobile communication terminals are being actively developed to provide data services such as a voice call, multimedia broadcast and streaming in line with activation of wireless multimedia data services. In addition, a PDA (Personal Digital Assistant) and a smart phone having a wireless network access function and a multimedia function have been developed.

Most convergence products providing diverse functions are manufactured with a dual-processor platform. Namely, the convergence product, in which an operating system is embedded, includes a main processor that executes and manages a user application such as a user interface, Word™, Excel™ and Internet Explorer™, and a communication processor that supports PCS (Personal Communication System)/Cellular or wireless communication.

Accordingly, interfacing between the dual processors of the convergence product has been a critical issue for its development. In particular, the inter-dual processor interfacing in a mobile terminal expects to have high power efficiency in consideration of a mobile environment and be designed to operate at a high speed to provide a fast video communication and streaming service. For this purpose, most convergence products employ a mutual interface using a USB (Universal Serial Bus), and some convergence products use a DPRAM (Dual Port Random Access Memory).

Since the USB transmits information of a few Mbps class, it is suitable for high-speed packet transmissions. And, standardized, it can interwork with a convergence product through various types of generalized and verified drivers. In case of using the DPRAM for communication between dual processors, the transmission rate is faster and power consumption is smaller than the case of using the USB, but a problem arises in that non-standardization of the interface hinders effective data processing.

### BRIEF DESCRIPTION OF THE INVENTION

Therefore, one object of the present invention is to provide a communication apparatus capable of transmitting data at a high speed by performing communication between dual processors of a mobile terminal through a DPRAM, and its method.

Another object of the present invention is to provide a communication apparatus capable of lowering power consumption by performing communication between dual processors of a mobile terminal through a DPRAM, and its method.

Still another object of the present invention is to provide a communication apparatus capable of enhancing QoS (Quality of Service) by effectively processing data by performing communication between dual processors of a mobile terminal through a DPRAM, and its method.

To achieve at least the above objects in whole or in parts, there is provided a communication apparatus comprising: a driving unit for fragmenting data packets inputted from a first processor, storing the fragmented data packets in a storage unit, reassembling the fragmented data packets, and transmitting the reassembled data packets to a second processor.

To achieve at least these advantages in whole or in parts, there is further provided a communication method comprising: fragmenting data packets inputted from a first processor; storing the fragmented data packets in a storage unit; reassembling the fragmented data packets stored in the storage unit; and transmitting the reassembled data packets to a second processor.

To achieve at least the above objects in whole or in parts, there is provided a communication apparatus comprising: a DPRAM (Dual Port Random Access Memory) driver for fragmenting data packets inputted from a first processor of a mobile terminal, storing the fragmented data packets in a DPRAM, reassembling the fragmented data packets based on an interrupt generated when the fragmented data packets are stored in the DPRAM; and transmitting the reassembled data packets to a second processor.

To achieve at least the above objects in whole or in parts, there is provided a communication apparatus comprising: a port mapper for receiving data packets transferred from application tasks of a first processor through a port with a priority level; a transmission unit for fragmenting the data packets according to a predetermined size and storing the fragmented data packets in a DPRAM; and a receiving unit for reading the segmented data packets stored in the DPRAM, reassembling the read segmented data packets, and transmitting the reassembled data packets to application tasks of a second processor through the port mapper.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a schematic block diagram showing the construction of a communication apparatus of a mobile terminal in accordance with the present invention;

FIG. 2 is a view illustrating the structure of a transmission frame used in the present invention;

FIG. 3 is a view illustrating the structure of a control byte used in the present invention;

FIG. 4 is a view illustrating the construction of a driver of a DPRAM of a communication device in accordance with the present invention;

FIG. 5 is a flow chart illustrating the processes of an operation of a packet fragmentizer of the driver of the DPRAM in accordance with the present invention; and

FIG. 6 is an exemplary view showing an operation of a packet reassembler for reassembling fragmented data frames into one data packet.

### DETAILED DESCRIPTION OF THE INVENTION

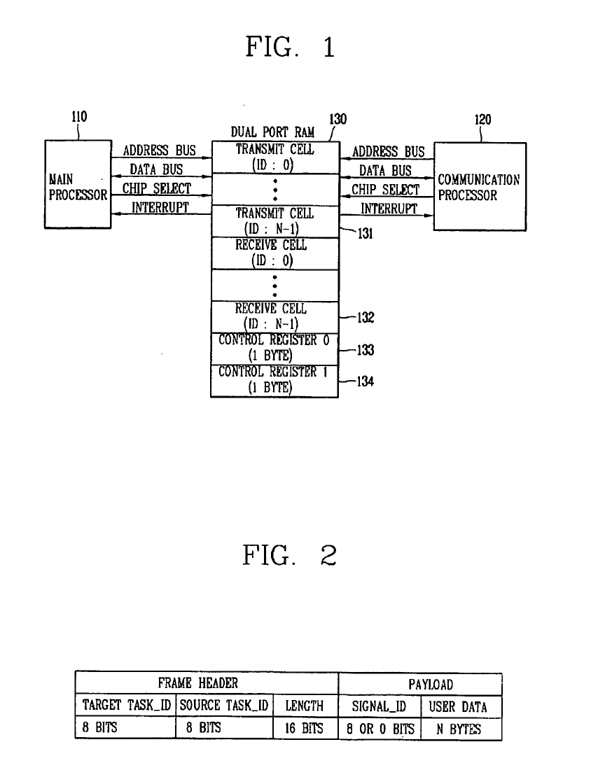

A communication apparatus and its method capable of transmitting data at high speed and reducing power consumption by fragmenting the data packets inputted from a first processor, storing the fragmented data packets in a storage unit, reassembling the fragmented data packets, and transmitting the reassembled data packets to a second processor, and enhancing a QoS (Quality of Service) by effectively processing data, in accordance with the present invention will be described with reference to FIGS. 1 to 6.

FIG. 1 is a schematic block diagram showing the construction of a communication apparatus of a mobile terminal in accordance with the present invention.

As shown in FIG. 1, the communication apparatus in accordance with the present invention includes a main processor 110; a communication processor 120, and a DPRAM 130 for performing communication between the main processor 110 and the communication processor 120 by fragmenting the data packets received from the main processor 110 or from the communication processor 120, storing the fragmented data packets and simultaneously generating an interrupt indicating that the data packets have been stored, reassembling the fragmented data packets, and transmitting the reassembled data packets.

The main processor 110 and the communication processor 120 schedule the data packets to be transmitted to the counter processor (e.g., to communication processor 120 and the main processor 120) according to priority, then fragment the scheduled data packets, and store the fragmented data packets in the DPRAM 130. The DPRAM 130 reassembles the stored fragmented data packets and transmits the reassembled data packets to the counter processor.

Accordingly, in the communication apparatus in accordance with the present invention, by fragmenting the data packets received from the main processor 110 or the communication processor 120, storing the fragmented data packets, reassembling the fragmented data packets, and transmitting the reassembled data packets, data can be transmitted at high speed and power consumption can be reduced. In addition, since the data can be effectively processed, the QoS can be enhanced.

The communication apparatus in accordance with the present invention can be implemented by the following three types.

1. The DPRAM 130 is designed as a physical layer in order to support power efficiency and transmission rate. For example, the DPRAM 130 is divided into the transmit cell region 131 for transmitting and a receive cell region 132 for receiving. The transmit cell region 131 and the receive cell region 132 are set to have an N number of cell. Herein, ‘N’ is a natural number and each cell corresponds to a region that is allocated to transfer one frame. In addition, the DPRAM 130 additionally includes a control register for storing a control byte for indicating storage position information (cell_ID) and transmission/reception state information (Sync_CTL) with respect to a data packet to be transmitted to the counter processor.

The transmit cell region 131 stores a frame (data packet) to be transmitted to the communication processor 120, and the receive cell region 132 stores a frame (data packet) to be transmitted to the main processor 110.

The control byte is set in a control register 0 133 and a control register 1 134 set in the DPRAM 130. Namely, the control byte is set in the control register 0 133 to transmit a data packet from the main processor 110 to the communication processor 120, and the control byte is set in the control register 1 134 to transmit a data packet from the communication processor 120 to the main processor 110.

The control byte is the storage position information (cell identifier (Cell_ID)) or the transmission/reception state set information (Sync_CTL), which can be changed and used according to an interface defined by a user.

The process in which the main processor 110 transmits and receives a frame (data packet) to and from the communication processor 120 through the DPRAM 130 will now be described.

First, in order to transmit a data packet from the main processor 110 to the communication processor 120, the DPRAM 130 writes a frame starting from a particular address and sets the control byte in the control register 0 133.

Thereafter, when a data packet is written in the transmit cell region 131 of the DPRAM 130, the DPRAM 130 generates an interrupt and transfers it to the communication processor 120 to inform the communication processor 120 that there is a data packet to be transmitted thereto. Then, an interrupt routine of the communication processor 120 reads the frame received from the DPRAM 130.

Meanwhile, in order to transmit data from the communication processor 120 to the main processor 110, the communication processor 120 drives a control register 1 134 to perform communication with the main processor 110 through the DPRAM 130.

The region of the DPRAM 130 is fragmented into a plurality of cells such that one cell is used to transmit only one frame. Namely, the size of the cell is defined as ‘maximum packet size+frame overhead size’ so that the data packet transmitted from the application task can be transmitted through one frame.

When the cell size cannot be set because of the limited physical size of the DPRAM 130, the cell size can be determined by equation (1) shown below by adjusting a scale value within a limitation that the physical size of the DPRAM 130 is satisfied by considering the length of each application packet and the packet frequency factor:
Cell_size=Frame Overhead+[scale xΣᵢ(PixFi/N)] (1)
wherein Pᵢ is the length of i^{th} packet, Fᵢ is the packet frequency factor, and ‘N’ is the sum of all of the packet frequency factors (F₁+F₂+, . . . , +Fₙ).

2. In designing a transmission frame structure for effective interfacing between the main processor 110 and the communication processor 120, the following matters may be considered.

1) The transmission frame structure includes appropriate addressing for inter-processor tasks.

2) The transmission frame structure has a structure that allows a packet to be fragmented and reassembled.

FIG. 2 is a view illustrating an exemplary structure of a transmission frame used in the present invention.

As shown in FIG. 2, a transmission frame stored in each cell defined in the transmit cell region 131 and the receive cell region 132 includes a frame header and a payload.

The frame header includes an 8-bit target Task_ID, an 8-bit source Task_ID, and a 16-bit length field. The payload includes an 8-bit Signal_ID and an N-byte application packet.

The target Task_ID is an identifier that is mapped in a 1:1 manner with a task for receiving a corresponding packet message, and the source Task_ID is an identifier that is mapped in a 1:1 manner with the application task transmitting a packet, and the length indicates the number of bytes of the payload field excluding the frame header.

The signal_ID is a type identifier field for distinguishing the type of event that is indicated by the user data transferred in the payload. An application task of a receiving side can interpret a user data packet based on the type identifier field.

If fragmented user data has been inserted in the payload, the signal_ID is included in the first fragmented data, but the fragmented data that follows the first fragmented data only includes user data without the signal_ID.

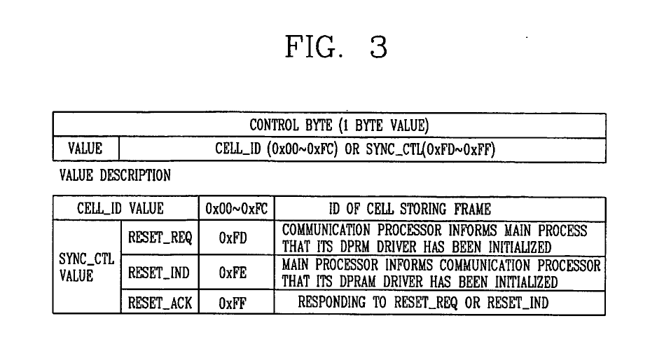

The structure of the 1-byte control byte stored in the control registers 133 and 134 of the DPRAM 130 will be described with reference to FIG. 3.

FIG. 3 is a view illustrating an exemplary structure of a control byte used in the present invention.

As shown in FIG. 3, the storage position information (Cell Identifier (Cell_ID)) or transmission/reception state set information (Sync_CTL) is stored in the control byte.

The Cell_ID is an ID of a cell having a frame stored therein. Namely, the Cell_ID refers to information that is set in the control register 133 or 134 after the transmission side copies a frame into a corresponding cell of the DPRAM 130 in order to transmit the frame. The receiving end can read the frame from a corresponding Cell_ID.

The Sync_CTL includes a reset request signal (RESET_REQ) used by the communication processor 120 to inform the main processor 110 that a DPRAM driver of the communication processor 120 has been initialized, and a reset indication signal (RESET_IND) used by the main processor 110 to inform the communication processor 120 that a DPRAM driver of the main processor 110 has been initialized, and a reset acknowledge signal (RESET_ACK) that is related to the reset request signal (RESET_REQ) or the reset indication signal (RESET_IND).

The Sync_CTL is a value set for making the communication states between the main processor 110 and the communication processor 120 correspond to each other, and can be used in the following process.

2-1. When power is applied or when the DPRAM driver of the main processor 110 is reset according to initialization, a DPRAM transmission driver of the main processor 110 transfers the reset indication signal (RESET_IND) to the communication processor 120 to inform that its DPRAM driver will be initialized, and proceeds with an initialization operation for communication.

Upon receiving the reset indication signal (RESET_IND), the communication processor 120 initializes its DPRAM status to make its communication state correspond to that of the main processor 110, and transfers the reset acknowledge signal (RESET_ACK) to the main processor 110.

Upon receiving the reset acknowledge signal (RESET_ACK), the main processor 110 recognizes that the communication processor 120 is ready for communication and starts communication.

2-2. Meanwhile, when the DPRAM driver of the communication processor 120 is reset, the communication processor 120 transmits a reset command signal (RESET_CMD) to the main processor 110, receives a reset acknowledge signal (RESET_ACK) from the main processor to make its communication preparation state correspond to that of the main processor 110, and performs communication.

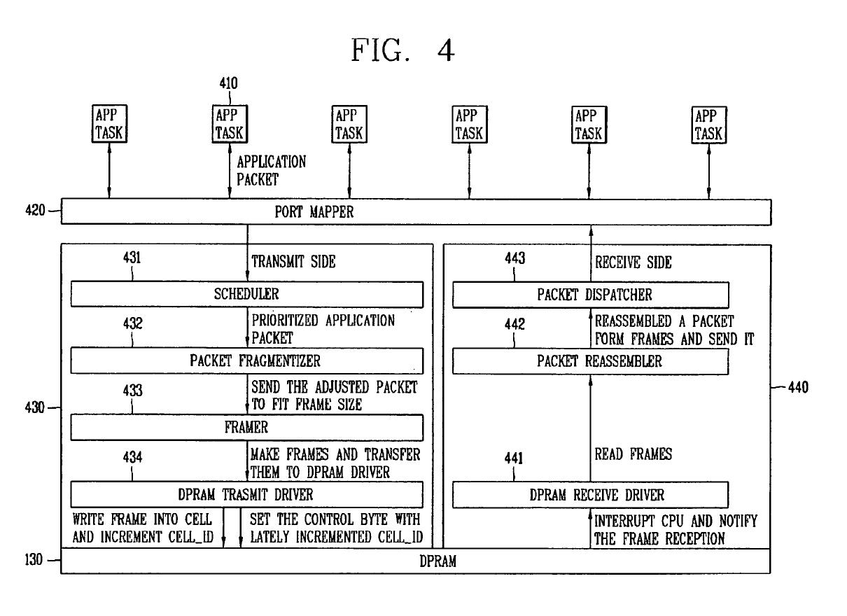

3. In one embodiment of the present invention, in order to process a data frame, the main processor 110 and the communication processor 120 are driven by a driver of the DPRAM 130 as shown in FIG. 4.

FIG. 4 is a view illustrating an exemplary construction of the driver of the DPRAM of a communication device in accordance with the present invention.

As shown in FIG. 4, the driver of the DPRAM 130 includes a port mapper 420 for receiving data packets transferred from application tasks 410 with a given priority level and managing an interface port database; a transmission unit 430 for fragmenting the data packets according to a predetermined size and transmitting the fragmented data packets to the DPRAM 130; and a receiving unit 440 for reading the fragmented data packets stored in the DPRAM 130, reassembling the read fragmented data packets, and transferring the reassembled data packets to corresponding application tasks.

The transmission unit 430 includes a scheduler 431 for scheduling data packets according to a priority level assigned to each port; a packet fragmentizer 432 for fragmenting the scheduled data packets according to a predetermined size; a framer 433 for converting the fragmented data packets into data frames; and a DPRAM transmit driver 434 for writing the data frames in the DPRAM 130.

The receiving unit 440 includes a DPRAM receive driver 441 for receiving the data frames written in the DPRAM 130; a packet reassembler 442 for reassembling the data frames received by the DPRAM receive driver 441; and a packet dispatcher 443 for dispatching the reassembled data frames to a target port.

The operation of the driver of the DPRAM 103 will now be described with reference to FIG. 4.

3-1. The port mapper 421 is a module for handling the interface procedures with the plurality of application tasks 410, and performs the generation, removal and management of an interface queue with a port database for interfacing with the application tasks 410.

The port database includes a Port_ID, Port_Activity, Priority, Target Task_ID, Source Task_ID, and Tx and Rx queue pointers for communication, and its operating method and operation are as follows.

The application task 410, which requires a communication service with tasks positioned at the counter processor (e.g., the main processor 110 or the communication processor 120) requests the port mapper 420 to open a port during its initialization.

When requesting opening of the port, the application task 410 registers its Task_ID and the Target Task_ID desired for communication and a service priority level to the port mapper 420.

The port mapper 420 generates a port database by using corresponding parameters (e.g., a particular Task_ID, the Target Task_ID), initializes port activity to an active state, generates Tx and Rx queues for communication, connects them to each queue pointer of the port database, and returns a port_ID to the application task 410 which has requested the service.

Then, the application task 410 can access a queue, to which it would transfer data, by using the corresponding Port_ID.

Thereafter, the application task 410 can access the queue of a port connected with the application task 410 itself by using the Port_ID, and transmit a data packet to the corresponding Tx queue to thereby transfer data to the counter process or receive data from an application task of the counter processor through an Rx queue.

When transmission data of the application task 410 is transferred to the Tx queue connected to the port, the port mapper 420 transfers the transmission data to a lower layer through the scheduler 431.

When reception data of the lower packet dispatcher 443 is transferred to the Rx queue connected to the port, the port mapper 420 transfers the corresponding data to the application task 410 according to a priority level described in the port database.

The priority level given to the port is defined according to service characteristics of each application task 410. For example, a higher priority level is given to a port allocated to an application which handles real-time data such as a voice service or real-time state checking, while a lower priority level is given to a port allocated to a data application which allows latency, to thereby satisfy the QoS (Quality of Service) requested by each service during congestion.

3-2. The scheduler 431 schedules data packets transferred from each application task 410 based on priority, and transfers the corresponding data packets to the lower packet fragmentizer 432 according to priority. The scheduler 431 checks a Tx queue of every port registered as active to the port mapper 420.

Upon checking, if application data to be transferred to the corresponding Tx queues is queued, the scheduler 431 performs priority-based scheduling to preferentially transfer the data packets queued in the port with high priority to the packet fragmentizer 432.

3-3. The packet fragmentizer 432 is a module for fragmenting data packets transferred from the scheduler 431 to transmit them as a data frame defined as shown in FIG. 2.

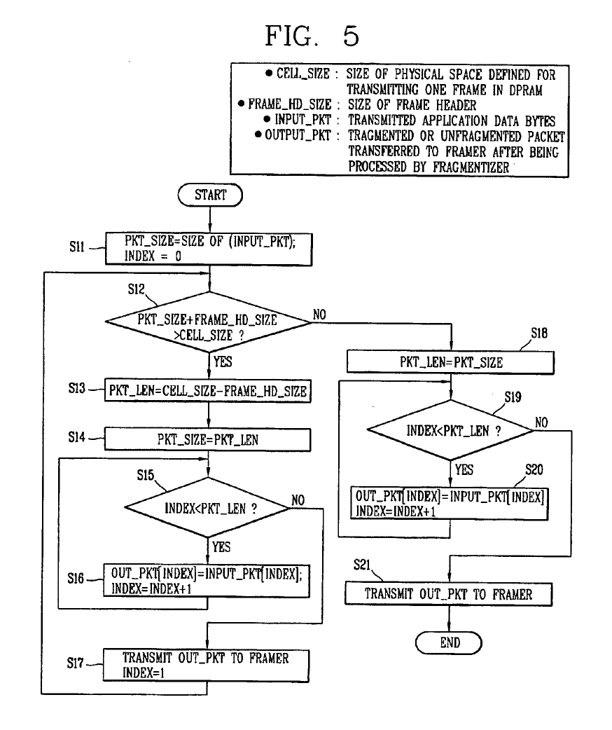

FIG. 5 is a flow chart illustrating the processes of an operation of the packet fragmentizer 432 of the driver of the DPRAM 103 in accordance with the present invention.

First, the packet fragmentizer 432 checks whether the sum of a size (Pkt_Size) of an input data packet and a size of a frame header (frame_Hd_Size) is larger than a cell size (Cell_Size) (steps S11 and S12). If the sum of a size of an input data packet and a size of a frame header is larger than a cell size, the packet fragmentizer 432 subtracts the size of the frame header from the cell size (step S13), a packet length (Pkt_len) of the subtracted size as a packet size (Pkt_Size) (step S14), and checks whether the packet length is smaller than an index (step S15).

If the packet length (Pkt_len) is larger than the index, the packet fragmentizer 432 sets an index (input_Pkt[index]) of the input packet as an index (Out_pkt[index]) of an output packet, increases the index by ‘1’, and returns to the process of comparing the packet length (Pkt_len) and the index (step S16).

If the packet fragmentizer 432 is the same as or smaller than the index, the packet fragmentizer 432 transfers the corresponding packet (Out_pkt) to the framer 433 and returns to the step S12 (step S17).

If the sum of a size of an input data packet and a size of a frame header is the same as or smaller than the cell size, the packet fragmentizer 432 sets the packet length (Pkt_len) as the packet size (Pkt_Size) (step S18) and checks whether the packet length (Pkt_len) is smaller than the index (step S19). If the packet length (Pkt_len) is larger than the index, the packet fragmentizer 432 sets the index (input_Pkt[index]) of the input packet as an index (Out_pkt[index]) of an output packet, increases the index by ‘1’, and returns to the process of comparing the packet length and the index (step S20). If the packet length (Pkt_len) is the same as or smaller than the index, the packet fragmentizer 432 transfers the corresponding packet (Out_pkt) to the framer 433 (step S21). Namely, if the sum of a size of an input data packet and a size of a frame header is larger than the cell size, the packet fragmentizer 432 fragments the corresponding packet into a plurality of packets and transfers the plurality of fragmented packets to the framer 433.

3-4. The framer 433 generates a data frame to be transferred to the DPRAM 130. Namely, the framer 433 receives one packet or the plurality of fragmented packets transferred from the packet fragmentizer 432, inserts the frame header (Frame_Header) defined as shown in FIG. 2 thereinto to generate one or a plurality of data frames, and transfers the generated data frame/frames to the DPRAM transmit driver 434.

In this case, the source Task_ID and the target Task_ID defined in the frame header are set as the source Task_ID and the target Task_ID values described in the port database, the length field of the frame header is set as the number of bytes of the transferred packets, and the frame payload is formed by copying the received packets by the units of byte.

Accordingly, the framer 433 generates the data frame as shown in FIG. 2, and transfers the at least one or more data frames as generated to the DPRAM transmit driver 434.

3-5. The DPRAM transmit driver 434 writes the data frames received from the framer 433 in the DPRAM 130. Herein, in order to operate each cell of the DPRAM 130 in a form of a ring buffer, the DPRAM transmit driver 434 may define and use a transmit point. The transmit pointer is a ring pointer indicating a cell ID of the DPRAM 130 for storing a frame to be transmitted, and is initialized as ‘0’ and also initialized as ‘0’ when a reset command is received. The transmit point is increased whenever a frame is written in the corresponding cell, and when the increased value reaches a maximum Cell_ID value, the transmit point is reset as ‘0’.

The DPRAM transmit driver 434 copies the received data frames in a cell of the DPRAM 130 indicated by the transmit pointer, and increases the value of the transmit pointer. In this case, when the frames are stored in the DPRAM 130, the DPRAM transmit driver 434 writes the value of the transmit pointer in the control register 133 or 134.

When the control register is set, the DPRAM 130 outputs an interrupt to the counter processor to inform the counter processor that a transmission frame is queued.

3-6. The DPRAM receive driver 441 is an interrupt handler for processing a reception interrupt of the DPRAM 130. When the DPRAM receive driver 441 is informed by an interrupt that frames are queued in the DPRAM 130, it reads the data frames from the corresponding cells of the DPRAM 130, and transfers the read data frames to the packet reassembler 442.

The DPRAM receive driver 441 operates the DPRAM 130 in a ring buffer form, for which the DPRAM receive driver 441 may define a receive pointer for accessing the DPRAM 130 and use it. The receive pointer stores a Cell_ID for reading a frame, and is initialized as ‘0’ and also initialized as ‘0’ when a reset command is received.

In a DPRAM interrupt service routine, it can be recognized how may frames are queued in the DPRAM 130 by comparing a value of the receive pointer and the Cell_ID value set in the control register 133 or 134 of the DPRAM 130. For example, the transmission unit 430 of the DPRAM 130 generates an interrupt by units of packet, so if a plurality of frames are queued, it means that one packet is fragmented into several frames and transmitted, and if one frame is queued, it means that the size of the data packet is so small that it is transmitted through one data frame.

The operation of the DPRAM receive driver 441 will now be described.

When an interrupt is generated, the DPRAM receive driver 441 reads the Cell_ID value set in the control register 133 or 134 of the DPRAM 130. The corresponding Cell_ID value indicates an ID of a cell in which the last data frame, among data frames to be read from the DPRAM, is stored.

In this case, the DPRAM receive driver 441 obtains the number of frames to be read by comparing an Rcv_Cell_ID value and a value of the receive pointer. For example, if the Rcv_Cell_ID is larger than the receive pointer, an arithmetic operation of ‘Num_of_Frame=Rcv_Cell_ID−Receive_Pointer’ is performed, and when the Rcv_Cell_ID is smaller than the receive pointer, an arithmetic operation of ‘Num_of_Frame=Cell_ID+N−Receive_Pointer’ is performed. Herein, Num_of_Frame is the number of frames to be read, Rcv_Cell_ID is a value read from the control register, and ‘N’ is a maximum Cell_ID value (the size of the ring buffer).

Thereafter, the DPRAM receive driver 441 reads the frames corresponding to the number of frames (Num_of_Frame) from the cell indicated by the receive pointer, and transmits the read frames to the packet reassembler 442. Herein, when the frames are read from each cell, the number of bytes corresponding to ‘Frame Header Size (4 bytes)+Frame Length Field value’, and in this case, the value of the receive pointer is increased by as many as the read cells.

The packet reassembler 442 receives one data frame or fragmented data frames, reassembles the fragmented data frames, and transfers the reassembled data frames to the packet dispatcher 443.

For example, in order to discriminate whether the received data packet has been fragmented or not, the packet reassembler 442 uses the value of the number of the frames (Num_of_Frame) calculated by the DPRAM receive driver 441. Namely, since the transmission side generates the interrupt for the receiving side by units of packets, if the value of the number of frames (Num_of_Frame) is ‘1’, it means that one complete data packet has been transferred through one data frame, and if the value of the number of frames (Num_of_Frame) is greater than ‘1’, it means that one data packet has been fragmented and transferred through several data frames. Accordingly, the packet reassembler 442 can easily discriminate whether the transferred data packet has been fragmented or not.

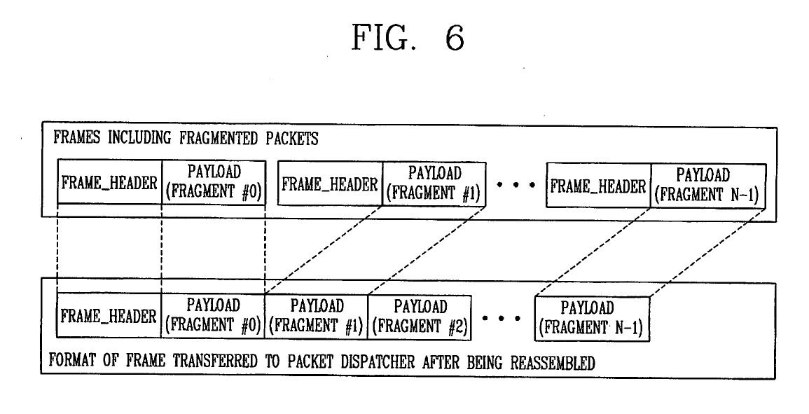

FIG. 6 is an exemplary view showing an operation of the packet reassembler 442 for reassembling fragmented data frames into one data packet.

First, when the value of the number of frames (Num_of_Frame) is ‘1’, the packet reassembler 442 transfers the received data frame directly to the packet dispatcher 443. In this case, if the value of the number of the frames (Num_of_Frame) is greater than ‘1’, the packet reassembler 442 checks whether the target Task_ID fields of the received data frames are the all the same and whether the source Task_ID fields are all the same.

If the target Task_ID fields and the source Task_ID fields of the received data frames are not the same, the packet reassembler 442 regards that an overflow has occurred in the counter processor, and transfers a reset command signal (RESET_CMD) to the counter processor to thereby initialize and synchronize DPRAM communication with the counter processor.

When the value of the number of frames (Num_of_Frame) is greater than ‘1’ and it has successfully passed the Task_ID checking, as shown in FIG. 6, the packet reassembler 442 removes the header starting from the second data frame and reassembles the data frames to constitute a data frame including complete data packets. In this case, the length of the reassembled frame header (Frame_Header) is set such that the number of bytes of the complete data packets transferred in a payload is updated.

The packet dispatcher 443 handles a function such as extracting original data packets from the reassembled data frame as received and dispatching the extracted data packets to a target task. For this purpose, the packet dispatcher 443 searches a port database which has the same value as the target Task_ID included in the header of the data frame and a set active flag, and obtains a Port_ID from the corresponding port database. Herein, the queue connected to each port can be accessed by using the corresponding Port_ID.

After the packet dispatcher 443 accesses a receive queue connected with the target application task 410 through the obtained Port_ID, stores a payload field except for the frame header (Frame_Header) in the corresponding queue, reads a signal ID of the frame payload, and informs the target application task 410 of the signal ID, to thereby access the packets stored in the receive queue.

The present invention can be applicable for a smart phone, a PDA and various mobile multimedia devices which have a dual processor.

As so far described, the communication apparatus and its method in accordance with the present invention have many advantages.

That is, for example, by fragmenting the data packet received from the main processor 110 or the communication processor 120, storing the fragmented data packets, reassembling them, and transmitting the reassembled data packet, the data can be transmitted at a high speed, power consumption can be lowered, and the data can be effectively processed, and thus, the QoS can be improved.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structure described herein as performing the recited function and not only structural equivalents but also equivalent structures.

What is claimed is:

1. A communication apparatus comprising:
a driving unit for fragmenting data packets inputted from a first processor, storing the fragmented data packets in a storage unit, reassembling the fragmented data packets, and transmitting the reassembled data packets to a second processor.

2. The apparatus of claim 1, wherein the first processor is a main processor or a communication processor of a mobile terminal.

3. The apparatus of claim 2, wherein the second processor is the main processor or the communication processor.

4. The apparatus of claim 1, wherein the driving unit reassembles the fragmented data packets and transmits the reassembled data packet to the second processor, based on an interrupt generated when the fragmented data packets are stored in the storage unit.

5. The apparatus of claim 1, wherein the storage unit comprises:
a transmit cell region including a plurality of transmission cells; and
a receive cell region including a plurality of reception cells.

6. The apparatus of claim 5, wherein the storage unit further comprises:
a control register for storing a control byte for indicating storage position information of the data packets and transmission/reception state setting information of the first and second processors.

7. The apparatus of claim 5, wherein the size of each cell is defined by the sum of the size of each data packet and the size of a frame overhead.

8. The apparatus of claim 5, wherein the size of each cell is determined by equation shown below:
Cell_size=Frame Overhead+[scale xΣᵢ(PixFi/N)]
wherein Pᵢ is the length of ith packet, Fᵢ is the packet frequency factor, and ‘N’ is the sum of all of the packet frequency factors.

9. The apparatus of claim 1, wherein the driving unit comprises:
a port mapper for receiving the data packets transferred from the application tasks through a port with given priority;
a transmission unit for fragmenting the data packets according to a predetermined size and storing the fragmented data packets in the storage unit; and
a receiving unit for reading the fragmented data packets stored in the storage unit, reassembling the read fragmented data packets, and transmitting the reassembled data packets to the corresponding application tasks through the port mapper.

10. The apparatus of claim 9, wherein the transmission unit comprises:
a scheduler for scheduling the data packets according to a priority level allocated to each port;
a packet fragmentizer for fragmenting the scheduled data packets according to a predetermined size;
a framer for converting the fragmented data packets into data frames; and
a transmit driver for writing the data frames in the storage unit.

11. The communication apparatus of claim 10, wherein when each size of the data packets is larger than the size of each cell of the storage unit, the packet fragmentizer fragments each data packet into a plurality of data packets.

12. The communication apparatus of claim 10, wherein when the sum of the size of each data packet and the size of the frame header is larger than the size of the cell of the storage unit, the packet fragmentizer fragments each data packet.

13. The communication apparatus of claim 10, wherein the framer generates the data frames by inserting a header to the data packets, which have been fragmented by the packet fragmentizer.

14. The communication apparatus of claim 10, wherein the receiving unit comprises:
a receive driver for receiving the data frames written in the storage unit;
a packet reassembler for reassembling the data frames received by the receive driver; and
a packet dispatcher for extracting the data packets from the reassembled data frames and dispatching the extracted data packets to a target port.

15. A communication method comprising:
fragmenting data packets inputted from a first processor;
storing the fragmented data packets in a storage unit;
reassembling the fragmented data packets stored in the storage unit; and
transmitting the reassembled data packets to a second processor.

16. A communication apparatus comprising:
a DPRAM (Dual Port Random Access Memory) driver for fragmenting data packets inputted from a first processor of a mobile terminal, storing the fragmented data packets in a DPRAM, reassembling the fragmented data packets based on an interrupt generated when the fragmented data packets are stored in the DPRAM; and transmitting the reassembled data packets to a second processor.

17. The apparatus of claim 16, wherein the DPRAM comprises:
a transmit cell region including a plurality of transmission cells;
a receive cell region including a plurality of reception cells; and
a control register for storing a control byte for indicating storage position information of the data packets and transmission/reception state setting information of the first and second processors.

18. The apparatus of claim 16, wherein the DPRAM driver comprises:
a port mapper for receiving the data packets transferred from the application tasks through a port with given priority;
a transmission unit for fragmenting the data packets according to a predetermined size and storing the fragmented data packets in the DPRAM; and
a receiving unit for reading the fragmented data packets stored in the DPRAM, reassembling the read fragmented data packets, and transmitting the reassembled data packets to the corresponding application tasks through the port mapper.

19. The apparatus of claim 9, wherein the transmission unit comprises:
a scheduler for scheduling the data packets according to a priority level allocated to each port;
a packet fragmentizer for fragmenting the scheduled data packets according to a predetermined size;
a framer for converting the fragmented data packets into data frames; and
a transmit driver for writing the data frames in the DPRAM.

20. A communication apparatus comprising:
a port mapper for receiving data packets transferred from application tasks of a first processor through a port with a priority level;
a transmission unit for fragmenting the data packets according to a predetermined size and storing the fragmented data packets in a DPRAM; and
a receiving unit for reading the segmented data packets stored in the DPRAM, reassembling the read segmented data packets, and transmitting the reassembled data packets to application tasks of a second processor through the port mapper.
